(19) United States
(12) Patent Application Publication
(10) Pub. No.: US 2010/0106860 A1
(43) Pub. Date: Apr. 29, 2010

(54) APPARATUS, SYSTEM FOR PROCESSING INTERNETWORK COMMUNICATION AND COMMUNICATION CONNECTION-ADAPTATION METHOD

(76) Inventors: Han Li, Beijing (CN); Congxing Ou Yang, Beijing (CN); Jianming Zhou, Beijing (CN); Xiaoyun Wang, Beijing (CN); Yuhong Huang, Beijing (CN); Bing Wei, Beijing (CN)

Correspondence Address: VENABLE LLP, P.O. BOX 34385, WASHINGTON, DC, 20043-9998, US

(21) Appl. No.: 12/532,383

(22) PCT Filed: Apr. 29, 2007
(86) PCT No.: PCT/CN07/01469

§ 371 Date: Nov. 12, 2009

(51) Int. Cl. G06F 15/16

(52) U.S. Cl. 709/250

(57) ABSTRACT

The invention relates to a network communication processing apparatus including: a communication connection selection and configuration unit and an internal interface unit connected in sequence. The invention relates to a network communication processing system including: a network communication processing apparatus, an external communication module and multiple network devices connected to the network communication processing apparatus. The present invention also relates to a method for communication connection adaptation comprising: identifying, by a network communication processing apparatus, available communication connection modes of a network device when it is connected; configuring the network device into a communication connection mode based on the available communication connection modes; and when the connection mode is changed, selecting, by the network communication processing apparatus, another connection mode and configures the network device into the another connection mode.

### FIELD OF THE INVENTION

The present invention relates to an apparatus and a system for network communication processing and a method for communication connection adaptation. In particular, the present invention relates to an apparatus and a system for network communication processing, which establish a connection adaptively by automatically identifying communication modes of network devices; the present invention also relates to a method for communication connection adaptation by means of the network communication processing apparatus.

### BACKGROUND OF THE INVENTION

In the information age, networking is getting increasingly popular, and household intelligence and networking are gradually coming into a reality. Currently various researches focused on an intelligent household network have been carried out, most of these researches are based on existing computer network technologies, which connects electrical appliances and apparatuses in a household through a network, and provides a user with rich, diverse, personalized, convenient, comfortable, safe and efficient services. One important topic in such researches is the exchange of internal and external information of a household, such as management and control of devices internal to the household using an external device by the user by means of the rapid developing mobile network, such management and control need an ideal home gateway.

A home gateway is a type of physical interface that connects an external access network of a household to the interior of the household and connects an internal network of the household to the exterior of the household, in addition, the home gateway is a platform that enables household users to obtain various home-based services (including existing services and future services that might emerge). The home gateway can receive a communication signal from an external network, and then send the signal through the household network to a certain household appliance. The application of the home gateway is not limited to high speed Internet access. The use of future broadband access in the household will bring forth more service contents, which include not only Internet access, but also video telephone that mixes video and audio information streams, and interactive entertainment services such as a network game. The home gateway performs an intelligent routing algorithm, to distribute the information streams (data) to various devices such as a telephone, intelligent appliances, digital TV and an audio device. For example, an advanced home gateway can forward a telephone call to a certain telephone in a household based on the ID information of the caller, so that telephone calls for the children are forwarded to the children's room only, or telephone calls (except emergency calls) are forwarded to only a telephone far away from the bed room after 10 o'clock at night.

Most of existing home gateways are centralized gateways, which manage both internal and external communication connections in the same way, and usually have one or more internal connection modes, for example, the home gateways may have an Ethernet interface or a wireless interface. A fixed connection mode is usually employed by a user to connect a network device in the household to the home gateway through the Ethernet mode or the wireless mode. However, when the fixed connection is interrupted, applications of upper layers are disrupted because of this interruption, and the user has to manually switch to another connection mode, which not only increases complexity of user operation, but also discontinues upper layer communication that exists before the interruption.

### SUMMARY

In view of the disadvantages in the existing network communication processing, the purpose of the present invention is to provide a network communication processing apparatus and system, as well as a method for communication connection adaptation, to automatically switch to another connection mode when the current connection mode of a network device is problematic.

In order to achieve the above purpose, the present invention provides a network communication processing apparatus, including:

a communication connection selection and configuration unit, adapted for automatically configuring and switching a connection between an internal network and an external communication network; and

an internal interface unit connected to the communication connection selection and configuration unit, adapted for connecting with network devices in the internal network.

In the above technical scheme, the internal interface unit includes: a Power Line Communication (PLC) modulation and demodulation unit connected to the communication connection selection and configuration unit, adapted for modulating and demodulating data signals and power line carrier signals, and for implementing the filtering and carrying of the data signals and the power line carrier signals. Additionally the internal interface unit may also includes: an optical access unit and/or an Ethernet interface unit and/or a wireless local area network access point, each of which is connected to the communication connection selection and configuration unit. The optical access unit is used for performing photoelectric conversion on optical signals, in order to obtain electric signals for communication; the Ethernet interface unit is used for connecting with network devices in the internal network through an Ethernet; and the wireless local area network access point is used for communicating with network devices in the internal network through a wireless mode.

The communication connection selection and configuration unit specifically includes:

multiple signal detection units, which are connected to the corresponding PLC modulation and demodulation unit and the optical access unit and/or the Ethernet interface unit and/or the wireless local area network access point, and used for detecting signals sent in various modes by network devices in the internal network;

a connection identification unit connected to the multiple signal detection units, adapted for identifying the detected signals sent in various modes by the network devices in the internal network, in order to identify various available connection modes of each of the network devices;

a selection and configuration file unit connected to a connection selection unit, adapted for providing priority information of connection modes for the connection selection unit; and

the connection selection unit connected to the connection identification unit and the selection and configuration file unit, adapted for selecting, for each of the network devices, one of the identified available connection modes of the network device according to the stored priority information of connection modes, in order to connect the network device in the internal network to the external network.

In order to achieve the above purpose, the present invention also provides a network communication processing system including the network communication processing apparatus, and the system further includes:

an external communication module connected to the communication connection selection and configuration unit of the network communication processing apparatus, adapted for processing internal Ethernet signals, and accomplishing the conversion between an Ethernet signal and an external access network signal; and

multiple network devices, connected to the internal interface unit of the network communication processing apparatus.

In the above technical scheme, the network communication processing system further includes PLC modems, which are connected to the multiple network devices respectively, connected to the PLC modulation and demodulation unit of the internal interface unit through an internal power network, and adapted for modulating and demodulating data signals and power line carrier signals. Additionally, the network communication processing system further includes a PLC signal isolator, which is provided between external power grid and the internal power network, and adapted for separating high frequency data signals from low frequency current signals in the power line.

In order to achieve the above purpose, the present invention provides a method for communication connection adaptation, comprising:

Step 1: identifying, by a network communication processing apparatus, available communication connection modes of a network device when the network device is connected to a network communication processing system;

Step 2: selecting, by the network communication processing apparatus, one of the available communication connection modes according to preset priority information, and establishing a connection between the network device and an external communication network through the selected communication connection mode; and

Step 3: when a change on the current connection mode of the network device is detected, reselecting, by the network communication processing apparatus, another available communication connection mode according to the preset priority information, and establishing the connection between the network device and the external communication network in the reselected communication connection mode.

In the above technical scheme, Step 1 specifically includes that: when the network device is connected to the network communication processing system through an internal interface unit, a signal detection unit detects and reports a connection signal of the network device to a connection identification unit; and the connection identification unit identifies the available communication connection modes of the network device.

Step 2 specifically includes that: according to the preset priority information in a selection and configuration file unit, a connection selection unit selects a communication connection mode from the available communication connection modes, to connect the network device in the internal network with an external network.

Step 3 specifically includes that: when a signal detection unit detects a change on the connection mode of the network device, the connection selection unit reselects another available communication connection mode according to the preset priority information, or selects forcedly a communication connection mode of a low priority according to a user instruction, to establish the connection between the network device and the external network using the reselected communication connection mode or the forcedly selected communication connection mode.

Before Step 1, the method may also includes a step of setting priorities including: setting connection priorities for an Ethernet connection, a PLC connection and a wireless connection based on the respective connection modes and bandwidth requirements, and storing the connection priorities in the selection and configuration file unit.

Based on the above technical schemes, the present invention is advantageous in that: connection modes such as Ethernet, PLC and wireless may be detected by a network communication processing apparatus in the present invention, and selected and adapted according to the detection results. If one of the connection modes is failed, the network communication processing apparatus can quickly switch to another connection mode, so as to ensure continuity of upper layer communication.

The present invention is further described in detail through the accompanying drawings and embodiments below.

### BRIEF DESCRIPTION OF THE DRAWINGS

FIG. 1 is a schematic illustration of the basic structure of a network communication processing apparatus according to the present invention;

FIG. 2 is a schematic illustration of the detailed structure of a network communication processing apparatus according to the present invention;

FIG. 3 is a schematic illustration of the composition of a network communication processing system according an embodiment of the present invention; and

FIG. 4 is a schematic illustration of the basic process of a method for communication connection adaptation according to the present invention.

### DETAILED DESCRIPTION OF THE EMBODIMENTS

In the present invention, a new type of network communication processing apparatus is used to construct a network communication processing system for household networking. The apparatus is compatible with several wireline and wireless connection modes, and can connect and communicate with various external access networks, thus implementing flexible control on an internal network by external devices. Additionally, the network communication processing apparatus has a capable of connection switching. When the connection mode of a device becomes unavailable, the network communication processing apparatus can adaptively switch to other available communication connection, thus implementing continuous and uninterrupted control of the device.

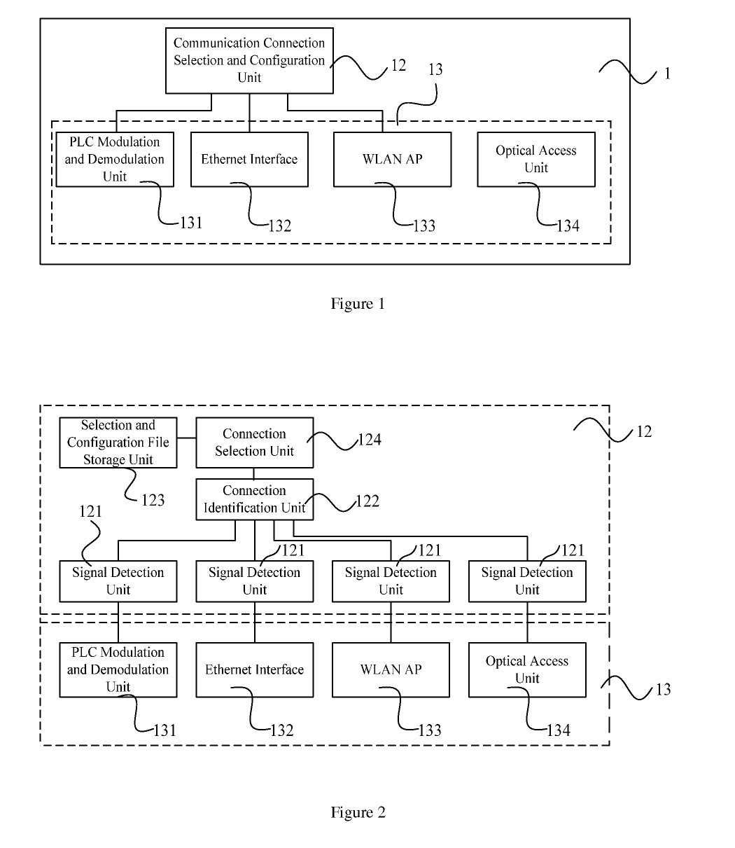

FIG. 1 is a schematic illustration of the basic structure of a network communication processing apparatus according to the present invention. The network communication processing apparatus 1 includes two basic components: an internal interface unit 13 connected to an internal network, and a communication connection selection and configuration unit 12 for automatic configuration and switching of communication connections. The communication connection selection and configuration unit 12, as a core component, is connected to the internal interface unit 13 and has a particular structure as shown in FIG. 2; the internal interface unit 13 can be configured according to the status of internal network devices; the internal interface unit 13 may includes: a Power Line Communication (PLC) modulation and demodulation unit 131, an Ethernet interface 132, a WLAN AP 133, and an optical access unit 134; the selection of the components in the internal interface unit 13 usually depends on the connection capability and connection status of internal network devices. For example, in the situation where only one connection mode is used in the internal network, the internal interface unit 13 may include the PLC modulation and demodulation unit 131 only; because power lines usually extend around in a household, and the internal interface unit 13 including the PLC modulation and demodulation unit 131 can be used in any room with a power socket, providing great convenience and usability. The PLC modulation and demodulation unit 131 is able to implement the demodulation and modulation of the power line carrier signals and data signals.

If more than one connection mode is used in the internal network, for example, if there are network devices with Ethernet interfaces or with wireless interfaces in the internal network, then the internal interface unit 13 may include the PLC modulation and demodulation unit 131 and the Ethernet interface 132, where the Ethernet interface unit 132 may connect to the network device in the internal network via an Ethernet mode. The connection modes (i.e. the PLC connection and the Ethernet connection) may be selected according to their preset priority information by the communication connection selection and configuration unit 12. Furthermore, the internal interface unit 13 may include the Ethernet interface 132 and the WLAN AP 133, so that the communication connection selection and configuration unit 12 may make selection between these two connection modes (i.e. the Ethernet connection and the wireless connection), where the WLAN AP 133 communicates with the network device in the internal network through a wireless mode. If some network devices in the household are provided with an optical fiber access mode, then the optical access unit 134 may be added to the internal interface unit 13, so that the optical fiber access mode becomes one of the connection modes available for selection.

FIG. 2 is a schematic illustration of the detailed structure of a network communication processing apparatus according to the present invention. A communication connection selection and configuration unit 12 includes: multiple signal detection units 121, which are connected to a PLC modulation and demodulation unit 131, an Ethernet interface 132, a WLAN AP 133 and an optical access unit 134 of an internal interface unit 13, respectively, and used for detecting a signal sent by a network device in the internal network; a connection identification unit 122 connected to the signal detection units 121, for identifying a connection signal of the network device, and obtaining available connection modes of the network device; a selection and configuration file unit 123, for storing priorities selected and configured for the connection modes, such as the operation priorities of the PLC mode, the Ethernet mode and the optical fiber mode; and a connection selection unit 124, which is connected to the connection identification unit 122 and the selection and configuration file unit 123, and is used for selecting an appropriate connection mode for the connection between the internal network and an external network, according to the selection and configuration file unit 123.

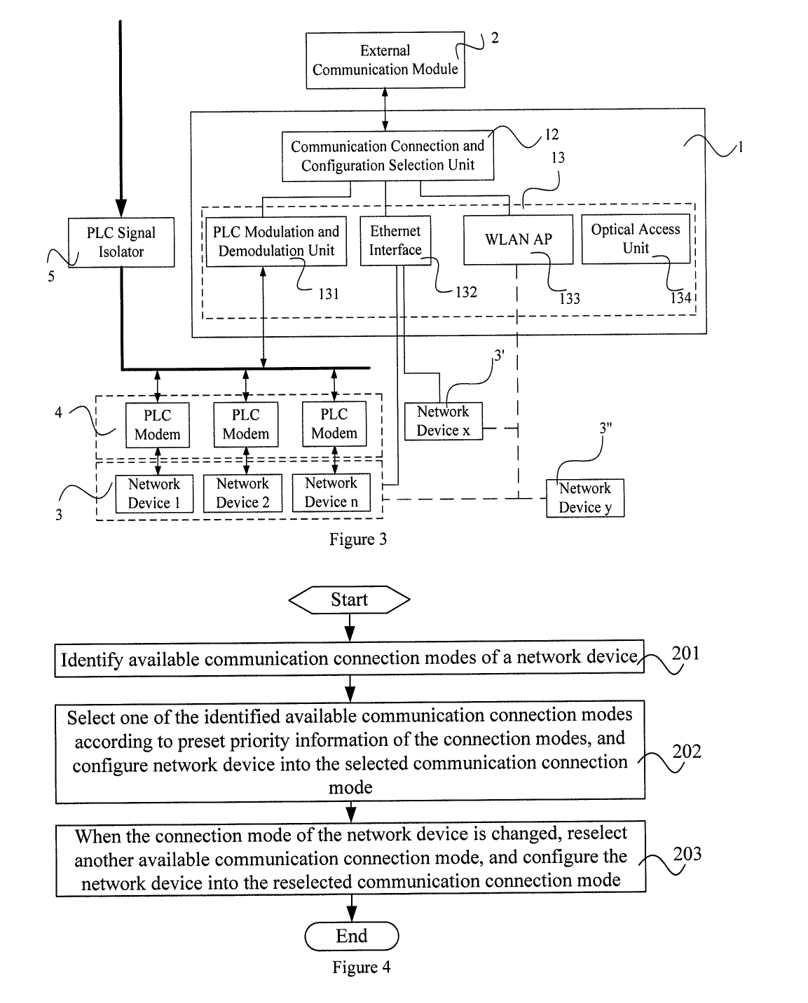

FIG. 3 is a schematic illustration of the composition of a network communication processing system according an embodiment of the present invention. The network communication processing system connects an external communication module with network devices in a household based on a network communication processing apparatus 1, so that a user or an application platform can control and manage the internal network of the household through the external communication module, enabling the controlling on a household network externally. There are many types of external access networks, such as an ADSL access system, an Ethernet access system, an optical fiber access system, a wireless broadband access system, a cable television system, a community network service system, and a telephone line access system; these external access networks can be accesses through an external communication module 2, which is capable of processing an internal Ethernet signal and accomplishing the conversion between the Ethernet signal and a signal of the external access network.

The internal network consists of network devices 1-n, which may be terminal devices such as a computer, an audio device, a television, a video recorder and a multimedia communication device; the connections between the network devices and the network communication processing apparatus 1 may be configured according to the structure of the internal interface unit 13 of the network communication processing apparatus 1. If the internal interface unit 13 includes an Ethernet interface 132, then a network device x 3′ may be connected to the Ethernet interface 132 through a Category-5 twisted pair line, such a wireline connection is characterized by a fast speed and high bandwidth, and can be configured as a general connection; if the internal interface unit 13 includes a WLAN AP 133, then a network device y 3″ may be connected to the WLAN AP 133 through a wireless mode; and if the internal interface unit 13 includes an optical access unit 134, then network devices may be connected to the optical access unit 134 through an optical fiber mode.

However, the deployment of the Category-5 twisted pair line is relatively complicated, and some network devices may not support wireless communication, hence preferably, the already-deployed power lines of a household may be used. Inside a household, power lines are the most widely deployed wireline transfer medium, the power line also receives relatively small interference, has a short transmission distance, and can meet the requirements for a bandwidth of 100 Mbps, further, most network devices need for power supply, hence the PLC mode may be adopted for communication.

When the PLC mode is used for communication, a data signal sent by a network device 3 needs to be modulated into a power line carrier signal by a PLC modem 4 before being inputted to the power line, and a power line carrier signal needs to be demodulated into a data signal to be sent to the network device. The filtering and carrying operations on a PCL signal are implemented by the PLC modulation and demodulation unit in the internal interface unit. Additionally, a PLC signal isolator 5 is provided in the power line between the external power grid and the internal power line network of the household, separating a low frequency current from the high frequency PLC signal, so that the high frequency PLC signal is prevented from being output to the external network, and an external high frequency PLC signal is prevented from entering the internal network of the household.

FIG. 4 is a schematic illustration of the basic process of a method for communication connection adaptation according to the present invention. The method includes the following steps.

Step 201: when a network device is connected to a network communication processing system, a network communication processing apparatus identifies available communication connection modes of the network device;

Step 202: the network communication processing apparatus selects one of the available communication connection modes according to the preset priority information of the connection modes, and configures the network device into the selected communication connection mode, that is, a connection between the network device and an external communication network is established using the selected communication connection mode; and

Step 203: when the connection mode of the network device changes, the network communication processing apparatus reselects another available communication connection mode according to the preset priority information of connection modes, and configures the network device into the reselected communication connection mode, that is, a connection between the network device and the external communication network is established using the reselected communication connection mode.

Before the network communication processing apparatus of the present invention is used to perform communication connection adaptation for the network device, the priority information of connection modes needs to be preset in the network communication processing apparatus.

In Step 201, the network device accesses the network communication processing system through the internal interface unit of the network communication processing apparatus. For example, when a personal computer is connected to the network communication processing system, the signal detection unit detects a connection signal from the personal computer, then reports the connection signal to a connection identification unit of the network communication processing apparatus; and the connection identification unit identifies the available communication connection modes of the personal computer, usually the personal computer may employ the Ethernet connection mode; if appropriate communication connection components are installed in the personal computer, such as a PLC network card or a wireless network card, then the connection identification unit identifies these connection modes as available communication connection modes. When accessing the network communication processing system, the network device may obtain a VLAN TAG through registration, so that the access by the internal network device is under the control of a safety strategy.

In Step 202, a connection selection unit in the network communication processing apparatus selects one of the determined control mode signals based on the available communication connection modes identified by the connection identification unit and the preset priority information; then selects a connection mode corresponding to the selected control mode signal, to connect the internal network of the household with the external network. For example, in the case where a network communication processing apparatus supports connection modes of PLC, twisted pair line and WLAN, eight different connection mode identification words can be formed with the above three connection modes, with “1” representing that a connection mode is available and “0” representing that the connection mode is unavailable; if the connection identification unit identifies that the personal computer supports the connection modes of PLC, twisted pair line and WLAN, a connection mode identification word “111” is formed; if the connection identification unit identifies that the personal computer only supports the connection mode of twisted pair line, the connection mode identification word is “010”. After the connection mode identification word is sent to the connection selection unit, the connection selection unit selects one of the determined control mode signal based on the priority information.

The priority information is usually set in advance, for example, by the manufacturer in the manufactory, or by the user. The priority of each connection mode may be determined by the user according to the arrangement in the household. The configurations of these priorities are stored in the selection and configuration file unit, and may be retrieved by the connection selection unit. For example, in a default state, the twisted pair line connection mode has the highest priority, the PLC connection mode has the second highest priority, and the WLAN connection mode has the lowest priority, thus, based on such priorities, the network communication processing apparatus configures the network device into an available communication connection mode with the highest priority; however, in a forced switching state, the network communication processing apparatus configures the network device into an available communication connection mode according to an instruction (such as a control word, that is, the control mode signal is selected according to the control word) from the user, instead of configuring the network device into an available communication connection mode with the highest priority according to the preset priorities.

In Step 203, when the connection mode of the network device changes (for example, the connection is interrupted for reasons such as power down, off line, software or hardware failures), the network communication processing apparatus reselects another available communication connection mode according to the preset priority information to establish a connection, It is also possible to forcedly establish a connection using a communication connection mode of a lower priority according to a received user instruction. Turning to the example of the personal computer, if a connection to a network is interrupted during the process of the personal computer accessing the network in the connection mode of the twisted pair line, the connection mode is switched automatically to the PLC connection mode, and subsequently to the WLAN connection mode if the PLC connection mode is unavailable, additionally, the user may instruct the network communication processing apparatus to directly switch to the WLAN connection mode.

The connection between an internal network and an external network is primarily for the implementation of external control on the internal network of the household. In an application of the invention, a user controls various household appliances in the household network through a telephone line network/mobile network, for example, the user uses a fixed-line telephone to dial a washing machine or an air conditioner equipped with a communication interface, in order to control the washing machine or air conditioner to switch on and off without a person around; the user may also use a mobile phone to check temperature and humidity of within the household, and adjust the output of the air conditioner, so as to ensure the interior of the household to be comfortable.

The network communication processing apparatus of the present invention may be applied to a household network, furthermore, the apparatus may be used in a local area network for connection selection and adaptation. Similarly, when a connection mode in the local area network in unavailable, the network communication processing apparatus can quickly switches to another connection mode, so as to ensure the continuity of upper layer communication.

It should be appreciated that the above embodiments are intended to describe the solutions of the present invention only, not to limit the invention. While the present invention has been described in detail with reference to the preferable embodiments, it will be appreciated to those skilled in the art that the embodiments of the invention may be modified, or partial technical features may be replaced with the equivalents thereof without departing from the scope of the technical solutions of the invention, and all the modifications and replacements are intended to be within the scope of the present invention.

1. A network communication processing apparatus, characterized by comprising:
a communication connection selection and configuration unit, adapted for automatically configuring and switching a connection between an internal network to an external communication network; and
an internal interface unit connected to the communication connection selection and configuration unit, adapted for connecting with network devices in the internal network.

2. The network communication processing apparatus of claim 1, wherein the internal interface unit comprises: a Power Line Communication modulation and demodulation unit connected to the communication connection selection and configuration unit, adapted for modulating and demodulating data signals and power line carrier signals, and implementing the filtering and carrying of the data signals and the power line carrier signals.

3. The network communication processing apparatus of claim 1, wherein the internal interface unit further comprises: an optical access unit and/or an Ethernet interface unit and/or a wireless local area network access point, each of which is connected to the communication connection selection and configuration unit; the optical access unit is used for performing photoelectric conversion on optical signals, in order to obtain electric signals for communication; the Ethernet interface unit is used for connecting with the network devices in the internal network through an Ethernet; and the wireless local area network access point is used for communicating with the network devices in the internal network through a wireless mode.

4. The network communication processing apparatus of claim 1, wherein the communication connection selection and configuration unit comprises:
a signal detection units connected to the internal interface unit, respectively, adapted for detecting signals sent in various modes by the network devices in the internal network;
a connection identification unit connected to the signal detection units, adapted for identifying the detected signals sent in various modes by the network device, to identify various available communication connection modes of the network device;
a selection and configuration file unit adapted for storing priority information of the connection modes; and
a connection selection unit connected to the connection identification unit and the selection and configuration file unit, adapted for selecting a connection mode from the identified various connection modes according to the stored priority information of connection modes, to connect the network device in the internal network to the external network.

5. A network communication processing system comprising the network communication processing apparatus of claim 4, characterized by further comprising:
an external communication module connected to a communication connection selection and configuration unit of the network communication processing apparatus, adapted for processing internal Ethernet signals, and accomplishing the conversion between an Ethernet signal and an external access network signal; and
multiple network devices connected to an internal interface unit of the network communication processing apparatus.

6. The network communication processing system of claim 5, further comprising: multiple Power Line Communication modems, which are connected to the multiple network devices respectively, connected to a Power Line Communication modulation and demodulation unit of the internal interface unit through an internal power network, and adapted for modulating and demodulating data signals and power line carrier signals.

7. The network communication processing system of claim 5, further comprising: a Power Line Communication signal isolator, which is provided between external power grid and the internal power network, and adapted for separating high frequency data signals from low frequency current signals in the power line.

8. A method for communication connection adaptation, comprising:
Step 1: identifying, by a network communication processing apparatus, available communication connection modes of a network device when the network device is connected to a network communication processing system;
Step 2: selecting, by the network communication processing apparatus, one of the available communication connection modes according to preset priority information, and establishing a connection between the network device and an external communication network through the selected communication connection mode; and
Step 3: when a change on the connection mode of the network device is detected, reselecting, by the network communication processing apparatus, another available communication connection mode according to the preset priority information, and establishing the connection between the network device and the external communication network through the reselected communication connection mode.

9. The method of claim 8, wherein Step 1 specifically comprises that:
when the network device is connected to the network communication processing system through an internal interface unit, a signal detection unit detects and reports a connection signal of the network device to a connection identification unit; and the connection identification unit identifies the available communication connection modes of the network device.

10. The method of claim 8, wherein Step 2 specifically comprises that: according to the preset priority information in a selection and configuration file unit, a connection selection unit selects a communication connection mode from the available communication connection modes, to connect the network device in the internal network with an external network.

11. The method of claim 8, wherein before Step 1, the method further comprises a step of setting priorities comprising: setting connection priorities for an Ethernet connection, a Power Line Communication connection and a wireless connection based on the respective connection modes and bandwidth requirements, and storing the connection priorities in the selection and configuration file unit.

12. The method of claim 8, wherein Step 3 specifically comprises that: when a change on the connection mode of the network device is detected by a signal detection unit, the connection selection unit reselects another available communication connection mode according to the preset priority information, or selects forcedly a communication connection mode of a low priority according to a user instruction, to establish the connection between the network device and the external communication network using the reselected communication connection mode or the forcedly selected communication connection mode.
